(19) United States
(12) Patent Application Publication
(10) Pub. No.: US 2025/0076455 A1
(43) Pub. Date: Mar. 6, 2025

(54) RADAR SIGNAL PROCESSING DEVICE, RADAR SIGNAL PROCESSING METHOD, AND TARGET OBSERVATION SYSTEM

(71) Applicant: Mitsubishi Electric Corporation, Tokyo (JP)

(72) Inventor: Tomoya Yamaoka, Tokyo (JP)

(73) Assignee: Mitsubishi Electric Corporation, Tokyo (JP)

(21) Appl. No.: 18/595,952

(22) Filed: Mar. 5, 2024

Related U.S. Application Data
(63) Continuation of application No. PCT/JP21/42352, filed on Nov. 18, 2021.

(51) Int. Cl. G01S 7/34; G01S 7/288; G01S 13/90

(52) U.S. Cl. CPC G01S 7/34; G01S 7/2883; G01S 13/9011; G01S 13/9021

(57) ABSTRACT

A radar signal processing device includes: a Fourier transform unit that Fourier transforms an image signal indicating a synthetic aperture radar image in an azimuth direction; and a map division unit that divides in a Doppler frequency domain a range Doppler frequency map indicated by a signal after the Fourier transform, and outputs signals that are a plurality of the divided range Doppler frequency maps; an inverse Fourier transform unit that inverse Fourier transforms signals indicating the divided maps output, and outputs divided playback signals that are signals after the inverse Fourier transform; a gain calculation unit that calculates a false image suppression gain for suppressing a false image of a target appearing in the synthetic aperture radar image using the divided playback signals output and the image signal; and a false image suppression unit that multiplies the image signal with the false image suppression gain calculated.

### CROSS REFERENCE TO RELATED APPLICATIONS

This application is a Continuation of PCT International Application No. PCT/JP2021/042352, filed on Nov. 18, 2021, which is hereby expressly incorporated by reference into the present application.

### TECHNICAL FIELD

The present disclosure relates to a radar signal processing device, a radar signal processing method, and a target observation system.

### BACKGROUND ART

An observation range of a Synthetic Aperture Radar (hereinafter, referred to as an “SAR image”) to be played back by a radar signal processing device is expanded by decreasing a Pulse Repetition Frequency (PRF) to be transmitted and received from an antenna. However, when the PRF is decreased, the number of sampling points in an azimuth direction becomes small, and therefore false images that are called azimuth ambiguity may appear in an SAR image.

There is a target observation system that includes a radar signal processing device that can suppress occurrence of azimuth ambiguity even when a PRF is decreased (see Non-Patent Literature 1). The target observation system includes a plurality of receivers. The radar signal processing device uses reception data of the plurality of receivers when playing back an SAR image, and consequently can suppress a decrease in the number of sampling points in an azimuth direction when the PRF is decreased compared to a radar signal processing device that plays back an SAR image using reception data of one receiver.

### CITATION LIST

### Patent Literatures

Non-Patent Literature 1: G. Krieger, N. Gebert, and A. Moreira, “Unambiguous SAR signal reconstruction from nonuniform displaced phase center sampling,” IEEE Geosci. Remote Sens. Lett., vol. 1, no. 4, pp. 260-264, October 2004.

### SUMMARY OF INVENTION

### Technical Problem

There has been a problem that the target observation system disclosed in Non-Patent Literature 1 needs to include a plurality of receivers to suppress azimuth ambiguity that appears in an SAR image.

The present disclosure has been made to solve the above problem, and an object of the present disclosure is to provide a radar signal processing device and a radar signal processing method that can suppress azimuth ambiguity that appears in an SAR image played back using only reception data of one receiver when a PRF is decreased.

### Solution to Problem

A radar signal processing device according to the present disclosure includes: a memory; and a processor to perform, upon executing a program stored in the memory, a process: to perform Fourier transform on an image signal indicating a synthetic aperture radar image in an azimuth direction; to divide in a Doppler frequency domain a range Doppler frequency map indicated by a signal after the Fourier transform, and output signals indicating divided maps that are a plurality of the divided range Doppler frequency maps; to perform inverse Fourier transform on signals indicating the divided maps output, and output divided playback signals that are signals after the inverse Fourier transform; to calculate a false image suppression gain for suppressing a false image of a target appearing in the synthetic aperture radar image using the divided playback signals output and the image signal; and to multiply the image signal with the false image suppression gain calculated.

### Advantageous Effects of Invention

According to the present disclosure, it is possible to suppress azimuth ambiguity that appears in an SAR image played back using only reception data of one receiver when a PRF is decreased.

### BRIEF DESCRIPTION OF DRAWINGS

FIG. 1 is a configuration diagram illustrating a target observation system including a radar signal processing device 30 according to Embodiment 1.

FIG. 2 is a configuration diagram illustrating a signal transmission/reception unit 20.

FIG. 3 is a configuration diagram illustrating the radar signal processing device 30 according to Embodiment 1.

FIG. 4 is a hardware configuration diagram of hardware of the radar signal processing device 30 according to Embodiment 1.

FIG. 5 is a hardware configuration diagram of a computer in a case where the radar signal processing device 30 is implemented by software, firmware, or the like.

FIG. 6 is a flowchart illustrating a radar signal processing method that is a processing procedure of the radar signal processing device 30.

FIG. 7 is an explanatory view illustrating an example of a range Doppler frequency map.

FIG. 8 is an explanatory view illustrating an example of the range Doppler frequency map after division by a map division unit 35.

FIG. 9 is a configuration diagram illustrating the radar signal processing device 30 according to Embodiment 2.

FIG. 10 is a hardware configuration diagram of hardware of the radar signal processing device 30 according to Embodiment 2.

### DESCRIPTION OF EMBODIMENTS

Hereinafter, embodiments for carrying out the present disclosure will be described with reference to the accompanying drawings to describe the present disclosure in more detail.

### Embodiment 1

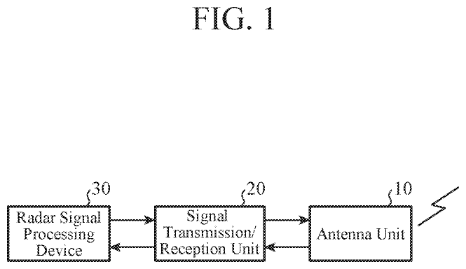

FIG. 1 is a configuration diagram illustrating a target observation system including a radar signal processing device 30 according to Embodiment 1.

The target observation system illustrated in FIG. 1 includes an antenna unit 10, a signal transmission/reception unit 20, and the radar signal processing device 30.

The antenna unit 10 radiates toward a target an electromagnetic wave related to a transmission signal output from the signal transmission/reception unit 20.

The antenna unit 10 receives a reflected wave of the electromagnetic wave from the target or the like, and outputs a reception signal of the reflected wave to the signal transmission/reception unit 20.

The signal transmission/reception unit 20 generates a transmission signal from a pulse signal generated by the radar signal processing device 30, and outputs the transmission signal to the antenna unit 10.

The signal transmission/reception unit 20 converts a reception signal output from the antenna unit 10 into a digital signal, and outputs reception data that is a digital signal to the radar signal processing device 30.

The radar signal processing device 30 generates the pulse signal, and outputs the pulse signal to the signal transmission/reception unit 20.

The radar signal processing device 30 plays back an SAR image from the reception data output from the signal transmission/reception unit 20.

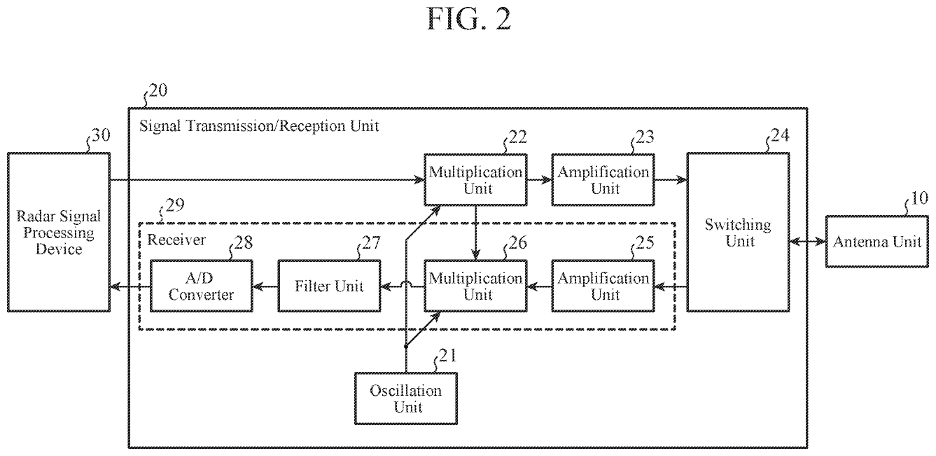

FIG. 2 is a configuration diagram illustrating the signal transmission/reception unit 20.

The signal transmission/reception unit 20 illustrated in FIG. 2 includes an oscillation unit 21, a multiplication unit 22, an amplification unit 23, a switching unit 24, and a receiver 29.

The receiver 29 includes an amplification unit 25, a multiplication unit 26, a filter unit 27, and an analog-digital conversion unit (hereinafter, referred to as an “A/D converter”) 28.

The receiver 29 performs reception processing on the reflected wave from the target or the like, and outputs the reception data of the reflected wave to the radar signal processing device 30.

In the target observation system illustrated in FIG. 1, the signal transmission/reception unit 20 includes only the one receiver 29. Even in a case where the signal transmission/reception unit 20 includes a plurality of the receivers 29, the radar signal processing device 30 can suppress azimuth ambiguity that appears in the SAR image.

The oscillation unit 21 generates a carrier wave, and outputs the carrier wave to each of the multiplication unit 22 and the multiplication unit 26.

The multiplication unit 22 multiplies the pulse signal output from the radar signal processing device 30 with the carrier wave output from the oscillation unit 21, and thereby up-converts the frequency of the pulse signal.

The multiplication unit 22 outputs the pulse signal after the frequency up-conversion as a transmission signal to the amplification unit 23.

The amplification unit 23 amplifies the transmission signal output from the multiplication unit 22, and outputs the transmission signal after the amplification to the switching unit 24.

The switching unit 24 outputs to the antenna unit 10 the transmission signal output from the amplification unit 23, and outputs to the amplification unit 25 a reception signal output from the antenna unit 10.

The amplification unit 25 amplifies the reception signal output from the switching unit 24, and outputs the reception signal after the amplification to the multiplication unit 26.

The multiplication unit 26 multiplies the reception signal output from the amplification unit 25 with the carrier wave output from the oscillation unit 21, and thereby down-converts the frequency of the reception signal.

The filter unit 27 suppresses an extra-band component included in the reception signal after the frequency down-conversion by the multiplication unit 26, and outputs the reception signal after the suppression of the extra-band component to the A/D converter 28.

The A/D converter 28 converts the reception signal output from the filter unit 27 from an analog signal into a digital signal.

The A/D converter 28 outputs the digital signal as reception data to the radar signal processing device 30.

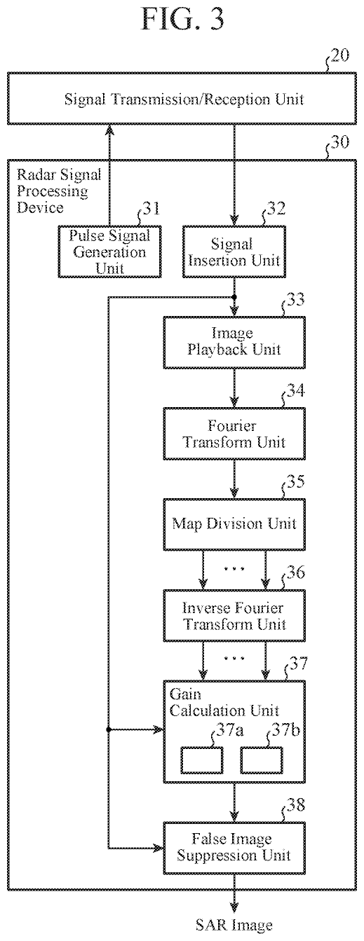

FIG. 3 is a configuration diagram illustrating the radar signal processing device 30 according to Embodiment 1.

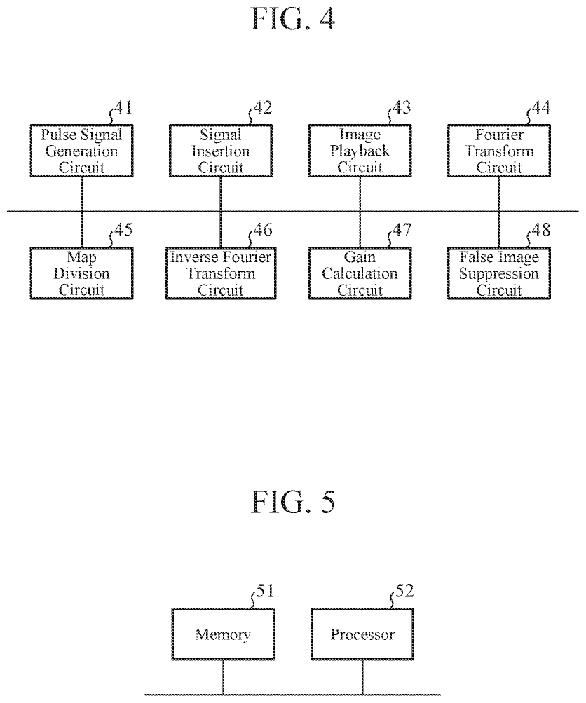

FIG. 4 is a hardware configuration diagram illustrating hardware of the radar signal processing device 30 according to Embodiment 1.

The radar signal processing device 30 illustrated in FIG. 3 includes a pulse signal generation unit 31, a signal insertion unit 32, an image playback unit 33, a Fourier transform unit 34, a map division unit 35, an inverse Fourier transform unit 36, a gain calculation unit 37, and a false image suppression unit 38.

The pulse signal generation unit 31 is implemented by, for example, a pulse signal generation circuit 41 illustrated in FIG. 4.

The pulse signal generation unit 31 repeatedly generates pulse signals, and repeatedly outputs the generated pulse signals to the multiplication unit 22.

The signal insertion unit 32 is implemented by, for example, a signal insertion circuit 42 illustrated in FIG. 4.

The signal insertion unit 32 repeatedly acquires the reception data output from the A/D converter 28.

The signal insertion unit 32 inserts a signal of 0 in a hit direction of each reception data.

The signal insertion unit 32 outputs each reception data after insertion of the signal of 0 to the image playback unit 33.

The image playback unit 33 is implemented by, for example, an image playback circuit 43 illustrated in FIG. 4.

The image playback unit 33 acquires each reception data after the insertion of the signal of 0 from the signal insertion unit 32.

The image playback unit 33 plays back an SAR image from each reception data after the insertion of the signal of 0.

When playing back the SAR image, the image playback unit 33 performs range cell migration correction on each of the true image and the false images of the target appearing in the SAR image.

The image playback unit 33 outputs an image signal indicating the SAR image to each of the Fourier transform unit 34, the gain calculation unit 37, and the false image suppression unit 38.

The Fourier transform unit 34 is implemented by, for example, a Fourier transform circuit 44 illustrated in FIG. 4.

The Fourier transform unit 34 acquires the image signal indicating the SAR image from the image playback unit 33.

The Fourier transform unit 34 performs Fourier transform on the image signal indicating the SAR image in the azimuth direction.

The Fourier transform unit 34 outputs the signal after the Fourier transform to the map division unit 35.

The map division unit 35 is implemented by, for example, a map division circuit 45 illustrated in FIG. 4.

The map division unit 35 divides in a Doppler frequency domain a range Doppler frequency map indicated by the signal after the Fourier transform by the Fourier transform unit 34.

The map division unit 35 outputs signals indicated by divided maps that are a plurality of the divided range Doppler frequency maps to the inverse Fourier transform unit 36.

The inverse Fourier transform unit 36 is implemented by, for example, an inverse Fourier transform circuit 46 illustrated in FIG. 4.

The inverse Fourier transform unit 36 acquires the signals indicating the plurality of divided maps from the map division unit 35.

The inverse Fourier transform unit 36 performs inverse Fourier transform on the signals indicating the divided maps, and outputs divided playback signals that are signals after the inverse Fourier transform to the gain calculation unit 37.

The gain calculation unit 37 is implemented by, for example, a gain calculation circuit 47 illustrated in FIG. 4.

The gain calculation unit 37 includes a pixel selection unit 37a and a gain calculation processing unit 37b.

The gain calculation unit 37 acquires the image signal indicating the SAR image from the image playback unit 33, and acquires the plurality of divided playback signals from the inverse Fourier transform unit 36.

The gain calculation unit 37 calculates a false image suppression gain for suppressing the false images of the target appearing in the SAR image using the divided playback signals and the image signal.

The gain calculation unit 37 outputs the false image suppression gain to the false image suppression unit 38.

The pixel selection unit 37a acquires the plurality of divided playback signals from the inverse Fourier transform unit 36.

The pixel selection unit 37a specifies in a divided playback image indicated by each of the plurality of divided playback signals each set of pixels taking the same pixel position in the image.

The pixel selection unit 37a selects an intensity minimum pixel that is a pixel whose intensity is minimum among a plurality of pixels included in each set.

The gain calculation processing unit 37b acquires the image signal indicating the SAR image from the image playback unit 33.

The gain calculation processing unit 37b specifies a pixel taking the same pixel position in the image as that of each intensity minimum pixel selected by the pixel selection unit 37a among the plurality of pixels included in the SAR image.

The gain calculation processing unit 37b divides the intensity of each intensity minimum pixel by the intensity of each specified pixel, and outputs an intensity division result as the false image suppression gain to the false image suppression unit 38.

The false image suppression unit 38 is implemented by, for example, a false image suppression circuit 48 illustrated in FIG. 4.

The false image suppression unit 38 acquires the image signal indicating the SAR image from the image playback unit 33, and acquires the false image suppression gain from the gain calculation unit 37.

The false image suppression unit 38 multiplies the image signal with the false image suppression gain. The SAR image indicated by the image signal after the gain multiplication by the false image suppression unit 38 has the suppressed azimuth ambiguity.

FIG. 1 assumes that each of the pulse signal generation unit 31, the signal insertion unit 32, the image playback unit 33, the Fourier transform unit 34, the map division unit 35, the inverse Fourier transform unit 36, the gain calculation unit 37, and the false image suppression unit 38 that are components of the radar signal processing device 30 is implemented by dedicated hardware illustrated in FIG. 4. That is, FIG. 1 assumes that the radar signal processing device 30 is implemented by the pulse signal generation circuit 41, the signal insertion circuit 42, the image playback circuit 43, the Fourier transform circuit 44, the map division circuit 45, the inverse Fourier transform circuit 46, the gain calculation circuit 47, and the false image suppression circuit 48.

Each of the pulse signal generation circuit 41, the signal insertion circuit 42, the image playback circuit 43, the Fourier transform circuit 44, the map division circuit 45, the inverse Fourier transform circuit 46, the gain calculation circuit 47, and the false image suppression circuit 48 corresponds to, for example, a single circuit, a composite circuit, a programmed processor, a parallelized processor, an Application Specific Integrated Circuit (ASIC), a Field-Programmable Gate Array (FPGA), or a combination of these.

The components of the radar signal processing device 30 are not limited to components that are implemented by dedicated hardware, and the radar signal processing device 30 may be implemented by software, firmware, a combination of software and firmware.

The software or the firmware is stored as a program in a memory of a computer. The computer means hardware that executes the program, and corresponds to, for example, a Central Processing Unit (CPU), a central processing device, a processing device, a computation device, a microprocessor, a microcomputer, a processor, or a Digital Signal Processor (DSP).

FIG. 5 is a hardware configuration diagram of the computer in a case where the radar signal processing device 30 is implemented by software, firmware, or the like.

In the case where the radar signal processing device 30 is implemented by software, firmware, and or the like, a program for causing the computer to execute a processing procedure of each of the pulse signal generation unit 31, the signal insertion unit 32, the image playback unit 33, the Fourier transform unit 34, the map division unit 35, the inverse Fourier transform unit 36, the gain calculation unit 37, and the false image suppression unit 38 is stored in a memory 51. Furthermore, a processor 52 of the computer executes the program stored in the memory 51.

Furthermore, FIG. 4 illustrates an example where each of the components of the radar signal processing device 30 is implemented by dedicated hardware, and FIG. 5 illustrates an example where the radar signal processing device 30 is implemented by software, firmware, or the like. However, this is merely an example, and part of the components of the radar signal processing device 30 may be implemented by dedicated hardware, and the rest of the components may be implemented by software, firmware, or the like.

Next, an operation of the target observation system illustrated in FIG. 1 will be described.

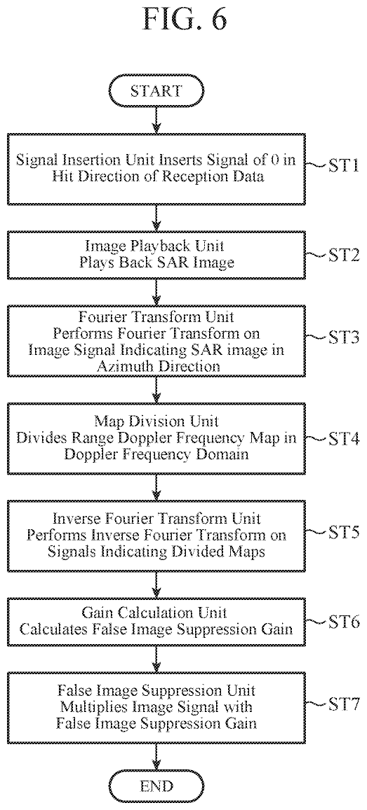

FIG. 6 is a flowchart illustrating a radar signal processing method that is a processing procedure of the radar signal processing device 30.

The pulse signal generation unit 31 of the radar signal processing device 30 repeatedly generates pulse signals, and repeatedly outputs the generated pulse signals to the multiplication unit 22.

The pulse signal to be generated by the pulse signal generation unit 31 may be, for example, a simple pulse signal, or may be a chirp pulse signal.

A PRF of the pulse signal to be generated by the pulse signal generation unit 31 is decreased to such a degree that, for example, azimuth ambiguity appears in an SAR image to expand an observation range of the SAR image.

The oscillation unit 21 of the signal transmission/reception unit 20 generates a carrier wave, and outputs the carrier wave to each of the multiplication unit 22 and the multiplication unit 26.

The multiplication unit 22 acquires the carrier wave from the oscillation unit 21.

The multiplication unit 22 repeatedly acquires the pulse signals from the radar signal processing device 30.

The multiplication unit 22 multiplies each acquired pulse signal with the carrier wave, and thereby up-converts the frequency of each pulse signal. The frequency of the pulse signal is up-converted by the multiplication unit 22 to, for example, the frequency of a high frequency band.

The multiplication unit 22 outputs each pulse signal after the frequency up-conversion as a transmission signal to the amplification unit 23.

The amplification unit 23 repeatedly acquires each transmission signal from the multiplication unit 22.

The amplification unit 23 amplifies each transmission signal, and outputs each transmission signal after the amplification to the switching unit 24.

Every time the switching unit 24 receives the transmission signal from the amplification unit 23, the switching unit 24 outputs the transmission signal to the antenna unit 10.

Every time the antenna unit 10 receives the transmission signal from the switching unit 24, the antenna unit 10 radiates an electromagnetic wave related to the transmission signal toward a target.

The electromagnetic wave related to the transmission signal is reflected by the target, a background of the target, or the like. The reflected wave from the target or the like is received by the antenna unit 10.

Every time the antenna unit 10 receives the reflected wave, the antenna unit 10 outputs a reception signal of the reflected wave to the switching unit 24 of the signal transmission/reception unit 20.

Every time the switching unit 24 receives the reception signal of the reflected wave from the antenna unit 10, the switching unit 24 outputs the reception signal to the amplification unit 25.

Every time the amplification unit 25 receives the reception signal from the switching unit 24, the amplification unit 25 amplifies the reception signal, and outputs the reception signal after the amplification to the multiplication unit 26.

Every time the multiplication unit 26 receives the reception signal after the amplification from the amplification unit 25, the multiplication unit 26 multiplies the reception signal with the carrier wave, and thereby down-converts the frequency of the reception signal. The frequency of the reception signal is down-converted by the multiplication unit 26 to, for example, the frequency of an intermediate frequency band.

The multiplication unit 26 outputs the reception signal after the frequency down-conversion to the filter unit 27.

Every time the filter unit 27 receives the reception signal after the frequency down-conversion from the multiplication unit 26, the filter unit 27 suppresses an extra-band component included in the reception signal, and outputs the reception signal after the suppression of the extra-band component to the A/D converter 28.

Every time the A/D converter 28 receives the reception signal after the suppression of the extra-band component from the filter unit 27, the A/D converter 28 converts the reception signal from an analog signal into a digital signal.

The A/D converter 28 outputs reception data s₀(n, h₀) that is the digital signal to the signal insertion unit 32 of the radar signal processing device 30. The reception data s₀(n, h₀) is expressed by a dimension of range-hit. n represents a range cell number, and h₀ represents a hit number for identifying a pulse signal related to a reflected wave.

The signal insertion unit 32 repeatedly acquires the reception data s₀(n, h₀) from the A/D converter 28.

Every time the signal insertion unit 32 acquires the reception data s₀(n, h₀), the signal insertion unit 32 inserts a signal of 0 in the hit direction of the reception data s₀(n, h₀) as expressed in the following equation (1) (step ST1 in FIG. 6).

The signal insertion unit 32 outputs each reception data s₁(n, h) after the insertion of the signal of 0 to the image playback unit 33.

$${s}_{1} ( n , h ) = \{ \begin{matrix}0 & ( h \neq {Mh}_{0} ) \\ {s}_{0} ( n , {h}_{0} ) & ( h = {Mh}_{0} )\end{matrix} \qquad ( 1 )$$

In the equation (1), M represents an integer equal to or more than two.

In a case of, for example, M=4, s₁(n, 4×h₀−3)=0, s₀(n, 4×h₀−2)=0, s₁(n, 4×h₀−1)=0, s₁(n, 4×h₀)=s₀(n, h₀), s₁(n, 4×h₀+1)=0, s₁(n, 4×h₀+2)=0, s₁(n, 4×h₀+3)=0, s₁(n, 4(h₀+1))=s0(n, h₀+1), and . . . hold.

The reception data s₁(n, h) expressed in the equation (1) includes s₀(n, h₀) at an interval of M. When the signal insertion unit 32 inserts the signal of 0 in the hit direction, the PRF increases M times. Furthermore, when the signal insertion unit 32 inserts the signal of 0 in the hit direction, a replica signal of a true image indicating the target is generated, and the replica signal becomes part of a false image.

In the radar signal processing device 30 illustrated in FIG. 3, the signal insertion unit 32 inserts the signal of 0 in the hit direction of the reception data s₀(n, h₀). Even in a case where the signal insertion unit 32 does not insert the signal of 0, if the observation range of the SAR image played back by the image playback unit 33 is sufficiently wide, the signal insertion unit 32 may omit processing of inserting the signal of 0 in the hit direction of the reception data s₀(n, h₀).

The image playback unit 33 acquires each reception data s₁(n, h) after the insertion of the signal of 0 from the signal insertion unit 32.

The image playback unit 33 plays back the SAR image from the reception data s₁(n, h) after the insertion of the signal of 0 (step ST2 in FIG. 6).

An SAR image playback method of the image playback unit 33 may be any method, and, for example, a range-Doppler method or a chirp scaling method can be used.

When playing back the SAR image, the image playback unit 33 performs range cell migration correction on each of the true image and the false images of the target appearing in the SAR image.

The image playback unit 33 outputs an image signal s₂(r, az) indicating the SAR image to each of the Fourier transform unit 34, the gain calculation unit 37, and the false image suppression unit 38. r represents a range bin number, and az represents an azimuth bin number.

In the radar signal processing device 30 illustrated in FIG. 3, the image playback unit 33 outputs the image signal s₂(r, az) to each of the Fourier transform unit 34, the gain calculation unit 37, and the false image suppression unit 38. However, this is merely an example, and the image playback unit 33 may output the image signal s₂(r, az) to an unillustrated storage device, and each of the Fourier transform unit 34, the gain calculation unit 37, and the false image suppression unit 38 may acquire the image signal s₂(r, az) from the storage device.

The Fourier transform unit 34 acquires the image signal s₂(r, az) indicating the SAR image from the image playback unit 33.

The Fourier transform unit 34 performs Fourier transform on the image signal s₂(r, az) indicating the SAR image in the azimuth direction (step ST3 in FIG. 6).

An example of a Fourier transform method for the image signal s₂(r, az) is Fast Fourier Transformation (FFT) or Discrete Fourier Transform (DFT).

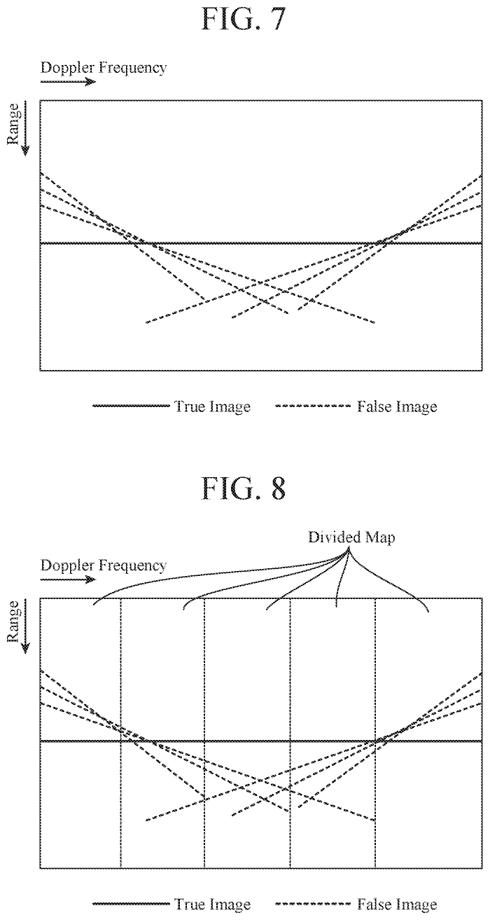

A signal s₂(r, f) after the Fourier transform by the Fourier transform unit 34 is a signal indicating a range Doppler frequency map illustrated in FIG. 7. f represents a Doppler frequency.

The Fourier transform unit 34 outputs the signal s₂(r, f) after the Fourier transform to the map division unit 35.

FIG. 7 is an explanatory view illustrating an example of the range Doppler frequency map.

In FIG. 7, the horizontal axis indicates a Doppler frequency, and the vertical axis indicates a range. The solid line indicates a true image indicating a target, and broken lines indicate false images.

As described above, when playing back the SAR image, the image playback unit 33 performs range cell migration correction on each of the true image and the false images of the target appearing in the SAR image. Hence, a range cell migration curve of a signal indicating the true image becomes a horizontal straight line parallel to the horizontal axis indicating the Doppler frequency domain. On the other hand, range cell migration curves of the false images whose ranges change as the Doppler frequency changes become line segments that diagonal to the horizontal axis indicating the Doppler frequency domain.

Accordingly, the true image is expressed as the horizontal straight line whose range does not change in the Doppler frequency band. On the other hand, the false images are expressed as the diagonal line segments whose ranges change in part of the Doppler frequency band.

The map division unit 35 acquires the signal s₂(r, f) after the Fourier transform from the Fourier transform unit 34.

As illustrated in FIG. 8, the map division unit 35 divides the range Doppler frequency map indicated by the signal s₂(r, f) after the Fourier transform in the Doppler frequency domain (step ST4 in FIG. 6).

FIG. 8 is an explanatory view illustrating an example of the range Doppler frequency map after the division by the map division unit 35.

In FIG. 8, the horizontal axis indicates a Doppler frequency, and the vertical axis indicates a range. The solid line indicates the true image indicating the target, and the broken lines indicate the false images.

FIG. 8 illustrates the example where the range Doppler frequency map is divided into five divided maps.

The true image is expressed as a horizontal straight line whose range does not change in the Doppler frequency band. Hence, even when the true image is divided in the Doppler frequency domain, the range of the true image at each Doppler frequency is the same.

On the other hand, the false images are expressed as diagonal line segments whose ranges change in part of the Doppler frequency band. Hence, the false images are divided in the Doppler frequency domain, and therefore the ranges of the false images at Doppler frequencies are shifted from each other.

The following equation (2) expresses division of the range Doppler frequency map by the map division unit 35. In an example of the equation (2), the range Doppler frequency map is divided into M divided maps.

The map division unit 35 outputs signals s_{3, m}(r, f) indicating the M divided maps to the inverse Fourier transform unit 36. m=1, . . . , and M hold.

$${S}_{3 , m} ( r , f ) = \{ \begin{matrix}0 & ( - \frac{MPRF}{2} \leq f < \frac{( 2 ( m - 1 ) - M ) PRF}{2} ) \\ {S}_{2} ( r , f ) & ( \frac{( 2 ( m - 1 ) - M ) PRF}{2} \leq f < \frac{( 2 m - M ) PRF}{2} ) \\ 0 & ( \frac{( 2 m - M ) PRF}{2} \leq f \leq \frac{MPRF}{2} )\end{matrix} \qquad ( 2 )$$

In the equation (2), the map division unit 35 divides the range Doppler frequency map in such a way that the widths in the Doppler frequency domain of the divided maps are equal. However, this is merely an example, and the map division unit 35 may divide the range Doppler frequency map in such a way that the widths of the Doppler frequency domain of the divided maps are unequal.

The inverse Fourier transform unit 36 acquires the signals s_{3, m}(r, f) indicating the M divided maps from the map division unit 35.

The inverse Fourier transform unit 36 performs inverse Fourier transform on the signals s_{3, m}(r, f) indicating the divided maps (step ST5 in FIG. 6).

An example of an inverse Fourier transform method for the signals s_{3, m}(r, f) indicating the divided maps is Inverse Fast Fourier Transformation (IFFT) or Inverse Discrete Fourier Transform (IDFT).

The inverse Fourier transform unit 36 outputs divided playback signals s_{3, m}(r, az) that are signals after the inverse Fourier transform to the gain calculation unit 37.

The gain calculation unit 37 acquires the M divided playback signals s_{3, m}(r, az) from the inverse Fourier transform unit 36.

The gain calculation unit 37 calculates a false image suppression gain g₀(r, az) using the M divided playback signals s_{3, m}(r, az) and the image signal s₂(r, az) indicating the SAR image (step ST6 in FIG. 6).

Gain calculation processing of the gain calculation unit 37 will be specifically described below.

The pixel selection unit 37a of the gain calculation unit 37 acquires the M divided playback signals s_{3, m}(r, az) from the inverse Fourier transform unit 36.

The pixel selection unit 37a specifies in a divided playback image indicated by each of the M divided playback signals s_{3, m}(r, az) each set of pixels taking the same pixel position in the image. In a case where, for example, the number of pixels in a horizontal direction of the divided playback image is H, and the number of pixels in a vertical direction of the divided playback image is V, the pixel selection unit 37a specifies H×V sets.

The pixel selection unit 37a compares absolute values |s_{3, 1}(r, az)| to |s_{3, M}(r, az)| of the intensities of a plurality of pixels included in each set.

The pixel selection unit 37a selects an intensity minimum pixel that is a pixel whose intensity is minimum among M pixels included in each set on the basis of an intensity comparison result.

As expressed in the following equation (3), the pixel selection unit 37a outputs min(|s_{3, m}(r, az)|) that is the absolute value of the intensity of the intensity minimum pixel as an intensity s₄(r, az) of the intensity minimum pixel to the gain calculation processing unit 37b.

The false images are divided in the Doppler frequency domain, and therefore the ranges of the false images at Doppler frequencies are shifted from each other. Hence, the intensity s₄(r, az) of the intensity minimum pixel is highly probably the intensity of a pixel that does not indicate a false image.

$${s}_{4} ( r , az ) = min ( \vert {s}_{3 , m} ( r , az ) \vert ) \qquad ( 3 )$$

The gain calculation processing unit 37b acquires the image signal s₂(r, az) indicating the SAR image from the image playback unit 33.

The gain calculation processing unit 37b specifies a pixel taking the same pixel position in the image as that of each intensity minimum pixel selected by the pixel selection unit 37a among the H×V pixels included in the SAR image.

As expressed in the following equation (4), the gain calculation processing unit 37b divides the intensity s₄(r, az) of each intensity minimum pixel by the absolute value |s₂(r, az)| of the intensity of each specified pixel.

The gain calculation processing unit 37b outputs an intensity division result as the false image suppression gain g₀(r, az) to the false image suppression unit 38.

$${g}_{0} ( r , az ) = \frac{{s}_{4} ( r , az )}{\vert {s}_{2} ( r , az ) \vert} \qquad ( 4 )$$

The false image suppression unit 38 acquires the image signal s₂(r, az) indicating the SAR image from the image playback unit 33, and acquires the false image suppression gain g₀(r, az) from the gain calculation unit 37.

As expressed in the following equation (5), the false image suppression unit 38 multiplies the image signal s₂(r, az) with the false image suppression gain g₀(r, az) (step ST7 in FIG. 6).

The SAR image indicated by an image signal s₅(r, az) after the gain multiplication by the false image suppression unit 38 has the suppressed azimuth ambiguity.

The false image suppression unit 38 causes an external display or the like to display the SAR image after the suppression of the azimuth ambiguity.

In the radar signal processing device 30 illustrated in FIG. 3, the false image suppression unit 38 causes the external display or the like to display the SAR image after the suppression of the azimuth ambiguity. However, this is merely an example, and the false image suppression unit 38 may cause the unillustrated storage device to store the image signal s₅(r, az) indicating the SAR image after the suppression of the azimuth ambiguity.

$${s}_{5} ( r , az ) = {g}_{0} ( r , az ) {s}_{2} ( r , az ) \qquad ( 5 )$$

In above Embodiment 1, the radar signal processing device 30 has been configured to include the Fourier transform unit 34 that performs Fourier transform on an image signal indicating a synthetic aperture radar image in the azimuth direction, and the map division unit 35 that divides in the Doppler frequency domain a range Doppler frequency map indicated by the signal after the Fourier transform by the Fourier transform unit 34, and outputs the signal indicating divided maps that are a plurality of the divided range Doppler frequency maps. Furthermore, the radar signal processing device 30 includes: the inverse Fourier transform unit 36 that performs inverse Fourier transform on the signals indicating the divided maps output from the map division unit 35, and outputs divided playback signals that are signals after the inverse Fourier transform, the gain calculation unit 37 that calculates a false image suppression gain for suppressing false images of a target appearing in the synthetic aperture radar image using the divided playback signals output from the inverse Fourier transform unit 36 and the image signal, and the false image suppression unit 38 that multiplies the image signal with the false image suppression gain calculated by the gain calculation unit 37. Consequently, the radar signal processing device 30 can suppress azimuth ambiguity appearing in the SAR image played back using only reception data of one receiver when a PRF is decreased.

In the radar signal processing device 30 illustrated in FIG. 3, the pixel selection unit 37a selects an intensity minimum pixel that is a pixel whose intensity is minimum among the M pixels included in each set on the basis of an intensity comparison result. Furthermore, the gain calculation processing unit 37b divides the intensity s₄(r, az) of each intensity minimum pixel by the absolute value |s₂(r, az)| of the intensity of each specified pixel. However, this is merely an example, and the pixel selection unit 37a calculates an average value of the intensities of the M pixels included in each set. Furthermore, the gain calculation processing unit 37b may divide the average value of the respective intensities by the absolute value |s₂(r, az)| of the intensity of each specified pixel. In this case, this division result is the false image suppression gain g₀(r, az).

### Embodiment 2

Embodiment 2 will describe the radar signal processing device 30 in which a gain calculation processing unit 37c adjusts the false image suppression gain g₀(r, az).

A configuration of a target observation system according to Embodiment 2 is the same as the configuration of the target observation system according to Embodiment 1, and a configuration diagram illustrating the target observation system according to Embodiment 2 is FIG. 1.

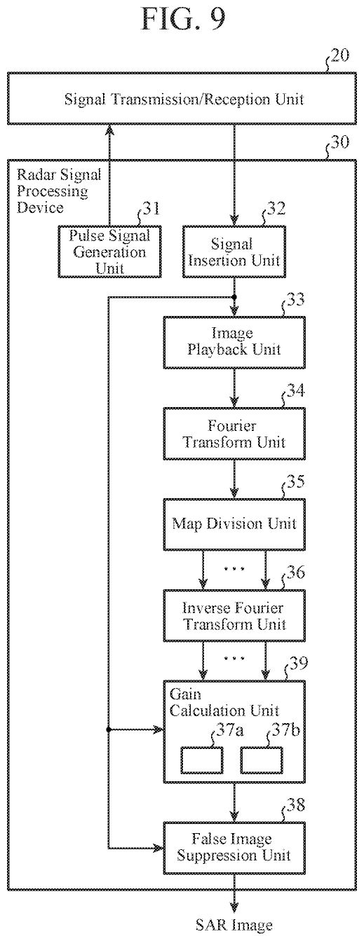

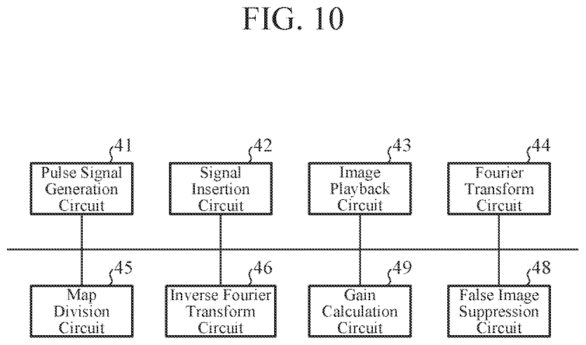

FIG. 9 is a configuration diagram illustrating the radar signal processing device 30 according to Embodiment 2.

FIG. 10 is a hardware configuration diagram illustrating hardware of the radar signal processing device 30 according to Embodiment 2.

The radar signal processing device 30 illustrated in FIG. 9 includes the pulse signal generation unit 31, the signal insertion unit 32, the image playback unit 33, the Fourier transform unit 34, the map division unit 35, the inverse Fourier transform unit 36, a gain calculation unit 39, and the false image suppression unit 38.

The gain calculation unit 39 is implemented by, for example, a gain calculation circuit 49 illustrated in FIG. 10.

The gain calculation unit 39 includes the pixel selection unit 37a and the gain calculation processing unit 37c.

Similar to the gain calculation unit 37 illustrated in FIG. 3, the gain calculation unit 39 calculates the false image suppression gain g₀(r, az) using an intensity comparison result and an image signal indicating an SAR image.

The gain calculation unit 39 adjusts the calculated false image suppression gain g₀(r, az), and outputs the false image suppression gain after the adjustment to the false image suppression unit 38.

Similar to the gain calculation processing unit 37b illustrated in FIG. 3, the gain calculation processing unit 37c divides the intensity s₄(r, az) of each intensity minimum pixel by the absolute value |s₂(r, az)| of the intensity of each specified pixel.

When the false image suppression gain g₀(r, az) that is the intensity division result is larger than one, the gain calculation processing unit 37c performs replacement processing of replacing the false image suppression gain g₀(r, az) with one.

Furthermore, the gain calculation processing unit 37c performs moving average processing on the false image suppression gain g₁(r, az) after the replacement processing.

Furthermore, the gain calculation processing unit 37c exponentiates a false image suppression gain g₂(r, az) after the moving average processing, and outputs a false image suppression gain g₃(r, az) after the exponentiation as a false image suppression gain to the false image suppression unit 38.

FIG. 9 assumes that each of the pulse signal generation unit 31, the signal insertion unit 32, the image playback unit 33, the Fourier transform unit 34, the map division unit 35, the inverse Fourier transform unit 36, the gain calculation unit 39, and the false image suppression unit 38 that are the components of the radar signal processing device 30 is implemented by dedicated hardware illustrated in FIG. 10. That is, FIG. 9 assumes that the radar signal processing device 30 is implemented by the pulse signal generation circuit 41, the signal insertion circuit 42, the image playback circuit 43, the Fourier transform circuit 44, the map division circuit 45, the inverse Fourier transform circuit 46, a gain calculation circuit 49, and the false image suppression circuit 48.

Each of the pulse signal generation circuit 41, the signal insertion circuit 42, the image playback circuit 43, the Fourier transform circuit 44, the map division circuit 45, the inverse Fourier transform circuit 46, the gain calculation circuit 49, and the false image suppression circuit 48 corresponds to, for example, a single circuit, a composite circuit, a programmed processor, a parallelized processor, an ASIC, an FPGA, or a combination of these.

The components of the radar signal processing device 30 are not limited to components that are implemented by dedicated hardware, and the radar signal processing device 30 may be implemented by software, firmware, a combination of software and firmware.

In the case where the radar signal processing device 30 is implemented by software, firmware, or the like such as a program for causing the computer to execute a processing procedure of each of the pulse signal generation unit 31, the signal insertion unit 32, the image playback unit 33, the Fourier transform unit 34, the map division unit 35, the inverse Fourier transform unit 36, the gain calculation unit 39, and the false image suppression unit 38 is stored in the memory 51 illustrated in FIG. 5. Furthermore, the processor 52 illustrated in FIG. 5 executes the program stored in the memory 51.

Furthermore, FIG. 10 illustrates an example where each of the components of the radar signal processing device 30 is implemented by dedicated hardware, and FIG. 5 illustrates the example where the radar signal processing device 30 is implemented by software, firmware, or the like. However, this is merely an example, and part of the components of the radar signal processing device 30 may be implemented by dedicated hardware, and the rest of the components may be implemented by software, firmware, or the like.

Next, an operation of the radar signal processing device 30 illustrated in FIG. 9 will be described. Operations other than that of the gain calculation unit 39 are the same as those in the radar signal processing device 30 illustrated in FIG. 3, and therefore the operation of the gain calculation unit 39 will be mainly described hereinafter.

Similar to the pixel selection unit 37a illustrated in FIG. 3, the pixel selection unit 37a of the gain calculation unit 39 selects an intensity minimum pixel that is a pixel whose intensity is minimum among a plurality of pixels included in each set.

The pixel selection unit 37a outputs min(|s_{3, m}(r, az)|) that is the absolute value of the intensity of the intensity minimum pixel as the intensity s₄(r, az) of the intensity minimum pixel to the gain calculation processing unit 37c.

Similar to the gain calculation processing unit 37b illustrated in FIG. 3, the gain calculation processing unit 37b acquires the image signal s₂(r, az) indicating the SAR image from the image playback unit 33.

Similar to the gain calculation processing unit 37b illustrated in FIG. 3, the gain calculation processing unit 37c specifies a pixel taking the same pixel position in the image as that of each intensity minimum pixel selected by the pixel selection unit 37a among the H×V pixels included in the SAR image.

Similar to the gain calculation processing unit 37b illustrated in FIG. 3, the gain calculation processing unit 37c divides the intensity s₄(r, az) of each intensity minimum pixel by the absolute value |s₂(r, az)| of the intensity of each specified pixel.

The gain calculation processing unit 37c performs adjustment processing on the false image suppression gain g₀(r, az) that is the intensity division result.

When the false image suppression gain g₀(r, az) is larger than one as expressed in the following equation (6), the gain calculation processing unit 37c performs replacement processing of replacing the false image suppression gain g₀(r, az) with g₁(r, az)=1.

When the false image suppression gain g₀(r, az) is one or less, the gain calculation processing unit 37c performs replacement processing of replacing the false image suppression gain g₀(r, az) with g₁(r, az).

$${g}_{1} ( r , az ) = \{ \begin{matrix}1 & ( 1 < {g}_{0} ( r , az ) ) \\ {g}_{0} ( r , az ) & ( 1 \geq {g}_{0} ( r , az ) )\end{matrix} \qquad ( 6 )$$

In the equation (6), g₁(r, az) is the false image suppression gain after the replacement processing by the gain calculation processing unit 37c.

Next, the gain calculation processing unit 37c performs moving average processing on the false image suppression gain g₁(r, az) to reduce noise included in the false image suppression gain g₁(r, az). The moving average processing itself is the known technique, and therefore detailed description thereof will be omitted. Each of the number of pixels and a coefficient for taking a moving average is arbitrary. Hereinafter, the false image suppression gain after the moving average processing is g₂(r, az).

Next, the gain calculation processing unit 37c exponentiates the false image suppression gain g₂(r, az) after the moving average processing as expressed in the following equation (7) to adjust a false image suppression effect.

The gain calculation processing unit 37c outputs the false image suppression gain g₃(r, az) after the exponentiation as a false image suppression gain to the false image suppression unit 38.

$${g}_{3} ( r , az ) = {g}_{2}^{α} ( r , az ) \qquad ( 7 )$$

In the equation (7), α represents an arbitrary value.

The false image suppression unit 38 acquires the image signal s₂(r, az) indicating the SAR image from the image playback unit 33, and acquires the false image suppression gain g₃(r, az) from the gain calculation unit 39.

The false image suppression unit 38 multiplies the image signal s₂(r, az) with the false image suppression gain g₃(r, az) as expressed in the following equation (8).

The false image suppression unit 38 causes the external display or the like to display, for example, the SAR image after the suppression of the azimuth ambiguity.

$${s}_{5} ( r , az ) = {g}_{3} ( r , az ) {s}_{2} ( r , az ) \qquad ( 8 )$$

In above Embodiment 2, the radar signal processing device 30 illustrated in FIG. 9 has been configured in such a way that the gain calculation processing unit 37c exponentiates the intensity division result, and outputs a division result after the exponentiation as the false image suppression gain to the false image suppression unit 38. Consequently, similar to the radar signal processing device 30 illustrated in FIG. 3, the radar signal processing device 30 illustrated in FIG. 9 can suppress azimuth ambiguity appearing in the SAR image played back using only reception data of one receiver when a PRF is decreased. Furthermore, the radar signal processing device 30 illustrated in FIG. 9 can enhance suppression accuracy for azimuth ambiguity compared to the radar signal processing device 30 illustrated in FIG. 3.

Note that the present disclosure enables free combination of the embodiments, modification of random components of each embodiment, or omission of random components in each embodiment.

### INDUSTRIAL APPLICABILITY

The present disclosure is suitable for a radar signal processing device, a radar signal processing method, and a target observation system.

### REFERENCE SIGNS LIST

10: antenna unit, 20: signal transmission/reception unit, 21: oscillation unit, 22: multiplication unit, 23: amplification unit, 24: switch unit, 25: amplification unit, 26: multiplication unit, 27: filter unit, 28: A/D converter, 29: receiver, 30: radar signal processing device, 31: pulse signal generation unit, 32: signal insertion unit, 33: image playback unit, 34: Fourier transform unit, 35: map division unit, 36: inverse Fourier transform unit, 37: gain calculation unit, 37a: pixel selection unit, 37b, 37c: gain calculation processing unit, 38: false image suppression unit, 39: gain calculation unit, 41: pulse signal generation circuit, 42: signal insertion circuit, 43: image playback circuit, 44: Fourier transform circuit, 45: map division circuit, 46: inverse Fourier transform circuit, 47, 49: gain calculation circuit, 48: false image suppression circuit, 51: memory, 52: processor.

1. A radar signal processing device comprising:
a memory; and
a processor to perform, upon executing a program stored in the memory, a process:
to perform Fourier transform on an image signal indicating a synthetic aperture radar image in an azimuth direction;
to divide in a Doppler frequency domain a range Doppler frequency map indicated by a signal after the Fourier transform, and output signals indicating divided maps that are a plurality of the divided range Doppler frequency maps;
to perform inverse Fourier transform on signals indicating the divided maps output, and output divided playback signals that are signals after the inverse Fourier transform;
to calculate a false image suppression gain for suppressing a false image of a target appearing in the synthetic aperture radar image using the divided playback signals output and the image signal; and
to multiply the image signal with the false image suppression gain calculated.

2. The radar signal processing device according to claim 1, wherein the process includes
to specify in an image each set of pixels taking a same pixel position in the image, and select an intensity minimum pixel that is a pixel whose intensity is minimum among a plurality of pixels included in each set, the image being indicated by each of a plurality of the divided playback signals output, and
to specify a pixel taking the same pixel position in the image as that of each intensity minimum pixel selected among a plurality of pixels included in the synthetic aperture radar image, divide an intensity of each intensity minimum pixel by an intensity of each specified pixel, and output a division result of the intensity as the false image suppression gain.

3. The radar signal processing device according to claim 2, wherein the process replaces the division result of the intensity with one when the division result of the intensity is larger than one.

4. The radar signal processing device according to claim 2, wherein the process performs moving average processing on the division result of the intensity, and outputs a division result after the moving average processing as the false image suppression gain.

5. The radar signal processing device according to claim 2, wherein the process exponentiates the division result of the intensity, and outputs a division result after the exponentiation as the false image suppression gain.

6. The radar signal processing device according to claim 1, the process further comprising:
to acquire, from a receiver, reception data of a reflected wave from a target, and insert a signal of 0 in a hit direction of the reception data; and
to play back the synthetic aperture radar image from the reception data after the insertion of the signal of 0, and output the image signal indicating the synthetic aperture radar image.

7. The radar signal processing device according to claim 6, wherein the process performs range cell migration correction on each of a true image and a false image of the target that appear in the synthetic aperture radar image.

8. A radar signal processing method comprising:
performing Fourier transform on an image signal indicating a synthetic aperture radar image in an azimuth direction;
dividing in a Doppler frequency domain a range Doppler frequency map indicated by the signal after the Fourier transform, and outputting signals indicating divided maps that are a plurality of the divided range Doppler frequency maps;
performing inverse Fourier transform on the signals indicating the divided maps output and outputting divided playback signals that are signals after the inverse Fourier transform;
calculating a false image suppression gain for suppressing a false image of a target appearing in the synthetic aperture radar image using the divided playback signals output and the image signal; and
multiplying the image signal with the false image suppression gain calculated.

9. A target observation system comprising:
a receiver to perform reception processing on a reflected wave from a target, and output reception data of the reflected wave;
a memory; and
a processor to perform, upon executing a program stored in the memory, a process:
to play back a synthetic aperture radar image from the reception data output from the receiver, and output an image signal indicating the synthetic aperture radar image;
to perform Fourier transform on the image signal output in an azimuth direction;
to divide in a Doppler frequency domain a range Doppler frequency map indicated by a signal after the Fourier transform and output signals indicating divided maps that are a plurality of the divided range Doppler frequency maps;
to perform inverse Fourier transform on signals indicating the divided maps output and output divided playback signals that are signals after the inverse Fourier transform;
to calculate a false image suppression gain for suppressing a false image of a target appearing in the synthetic aperture radar image using the divided playback signals output and the image signal; and
to multiply the image signal with the false image suppression gain calculated.

10. The target observation system according to claim 9, the process further comprising to acquire, from the receiver, reception data of a reflected wave from a target, and insert a signal of 0 in a hit direction of the reception data,
wherein the process plays back the synthetic aperture radar image from the reception data after the insertion of the signal of 0.
